(19) United States
(12) Patent Application Publication
(10) Pub. No.: US 2017/0369179 A1
(43) Pub. Date: Dec. 28, 2017

(54) GAS TURBINE ENGINE

(71) Applicant: ROLLS-ROYCE plc, London (GB)

(72) Inventor: Stephen J. BRADBROOK, Clevedon (GB)

(73) Assignee: ROLLS-ROYCE plc, London (GB)

(21) Appl. No.: 15/605,125

(22) Filed: May 25, 2017

(30) Foreign Application Priority Data
Jun. 22, 2016 (GB) 1610878.9

(51) Int. Cl. B64D 35/04; F02C 3/04; B64D 27/12; F02C 7/18; B64D 27/18; B64D 27/00

(52) U.S. Cl. CPC B64D 35/04; F02C 7/18; B64D 27/18; F02C 3/04; B64D 27/12; B64D 2027/005; F05D 2220/323; F05D 2240/35; F05D 2260/213

(57) ABSTRACT

An aircraft gas turbine engine (110) comprises first and second non-coaxial propulsors (113a, 113b), each propulsor (113a, 113b) being driven by a common gas turbine engine core (176) comprising a propulsor drive turbine (143) arranged to drive the first and second propulsors (113a, 113b) via a propulsor drive coupling (127). The core (176) further comprises a first core module (190) comprising a first compressor (129) and a first turbine (131) interconnected by a first shaft (177), and a second core module (191) comprising a second compressor (128) and the propulsor drive turbine (143) interconnected by a second shaft (127), the first and second core modules (190, 191) being axially spaced.

### FIELD OF THE INVENTION

The present invention relates to a gas turbine engine, particularly to a gas turbine engine suitable for use on an aircraft, and an aircraft comprising a gas turbine engine.

### BACKGROUND TO THE INVENTION

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 24. A nacelle 21 generally surrounds the engine 10 and defines both the intake 12 and a bypass exhaust nozzle 20.

The gas turbine engine 10 works in the conventional manner so that air entering the intake 12 is accelerated by the fan 13 to produce two air flows: a first air flow A into the intermediate pressure compressor 14 and a second air flow B which passes through a bypass duct defined by an internal space between a radially inner side of the engine nacelle 21 and a radially outer side of a core nacelle 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 24 to provide additional propulsive thrust. The high 17, intermediate 18 and low 19 pressure turbines drive respectively the high pressure compressor 15, intermediate pressure compressor 14 and fan 13, each by suitable interconnecting shafts. The compressors 14, 15, combustor 16 and turbines 17, 18, 19 define an engine core, and are housed within the core nacelle 22. The core nacelle 22 defines a core inlet 23 at an axially forward end, and a core exhaust 24 at an axially rearward end.

A figure of merit for gas turbine engines is the “bypass ratio”, i.e. the ratio of air mass flow which bypasses the core, relative to the mass flow which flows through the core. In general, at subsonic and transonic speeds, higher bypass ratios result in higher propulsive efficiency, and therefore lower specific fuel consumption. Large bypass ratios imply a large fan diameter for a given overall thrust. Such engines are typically installed on aircraft on pylons located underneath, or slightly forward of the wing. Consequently, in order to provide adequate ground clearance with a high bypass ratio engine installed beneath a wing, long landing gear legs are required, which results in high weight, and may make egress from the aircraft in the event of an emergency difficult, in view of the long distance between the aircraft fuselage and the ground. U.S. Pat. No. 8,402,740 describes one such prior example.

It is also desirable to increase the thermal efficiency of the gas turbine engine. It is known to provide one or both of intercooling and recuperation to increase the thermal efficiency. Intercooling arrangements comprise a heat exchanger having a hot side in thermal contact with compressed air, upstream of further compression stages, and a cold side in thermal contact with a cold sink such as bypass flow. For example, the hot side may be located between an outlet of a booster or intermediate pressure compressor, and an inlet of a high pressure compressor. By reducing the temperature of the compressed air prior to further compression, the work required to compress the air further is reduced. Similarly, a recuperator arrangement comprises a heat exchanger having a hot side in thermal contact with an area downstream of the engine combustor (such as downstream of the final turbine stage), and a cold side in thermal contact with a combustor inlet. Consequently, waste heat is recycled into the engine, thereby increasing thermal efficiency. However, such systems add weight and complexity to engines, and are difficult to package in the limited space available.

The present invention seeks to provide an aircraft gas turbine engine which overcomes or ameliorates some or all of the above problems.

### SUMMARY OF THE INVENTION

According to a first aspect of the present invention, there is provided an aircraft gas turbine engine comprising:

first and second non-coaxial propulsors, each propulsor being driven by a common gas turbine engine core comprising a propulsor drive turbine arranged to drive the first and second propulsors via a propulsor drive coupling;

wherein the core comprises a first core module comprising a first compressor and a first turbine interconnected by a first shaft, and a second core module comprising a second compressor and the propulsor drive turbine interconnected by a second shaft, the first and second core modules being axially spaced.

Advantageously, such an arrangement provides a gas turbine engine having a high bypass ratio with a relatively small fan diameter, thereby permitting installation underneath an aircraft wing. At the same time, the engine has multiple compressors operating at their respective ideal speeds driven by separate shafts and separate, without requiring a shaft interconnecting the fan drive turbine and the fan which passes through the centre of the other shaft. Consequently, shaft lengths can be reduced, thereby reducing vibration and weight, while disc diameters can also be reduced.

Each propulsor may comprise a ducted fan or an un-ducted propeller.

The core may comprise a compressor provided axially rearwardly of the propulsor drive turbine.

The propulsor drive coupling may be arranged such that the propulsor drive turbine rotates at a higher rotational speed than the propulsor in use. The propulsor drive coupling may comprise a mechanical gearbox.

The gas turbine engine gearbox may comprise a common input shaft coupled to the propulsor drive turbine, and first and second output shafts coupled to the first and second propulsors respectively. The gearbox may comprise a bevel gear arrangement. The gearbox may comprise a reduction gearbox, such that the input shaft rotates at a higher speed in use than the first and second output shafts. The gearbox may comprise an input:output ratio of between 1 and 5. It is has been found that the present invention is particularly advantageous where the gearbox comprises a reduction gearbox. Reduction gearboxes permit relatively high speed fan drive turbines to be employed, which increases the efficiency of the turbine, while reducing the number of turbine stages that are required, and reducing the diameter of the turbine, thereby reducing the weight and cost of the fan drive turbine. Consequently, the input shaft which interconnects the fan drive turbine and gearbox rotates at a relatively high speed. As a result, the torque carried by the input shaft is relatively low for a given power. This in turn means that a relatively thin, low diameter input shaft relative to the diameter of the core can be employed. Such shafts reduce weight further, but may result in bending or “whirl” modes of vibration. By employing a turbine engine core in which the fan drive turbine is provided as part of a second core module which is axially spaced from a first core module, the fan drive input shaft length is reduced, thereby ameliorating this issue.

Alternatively, the propulsor drive coupling may comprise a propulsor drive turbine driven electrical generator and first and second electrical motors coupled to respective propulsors, the generator being electrically coupled to the first and second motors. Consequently, the propulsor drive turbine can be situated remotely from the propulsors, without requiring a relatively heavy mechanical transmission system.

The electrical generator may comprise an AC generator, and each electrical motor may comprise an AC motor, the generator and electrical motors being coupled by an AC electrical interconnector. The electrical motors may comprise a power electronics unit configured to modulate the frequency of electrical power delivered to the respective electric motor. Thereby, the speed of each fan can be controlled independently of the speed of the propulsor drive turbines.

The first and second propulsors may be co-planar, being provided at substantially the same axial position, though having non-coincident axes of rotation. Each propulsor may comprise a single stage fan, having an outlet guide vane arrangement downstream. The or each propulsor may comprise fixed or variable pitch rotor blades. The gearbox may comprise a differential drive. Where the gearbox comprises a differential drive, and the first and second fans have variable pitch, the fan speed of the first and second fans can be controlled independently by differentially controlling the pitch of the fans, and thereby differentially controlling the load on the respective output shafts. At the same time, fan operating margin can be controlled using the fan pitch. Furthermore, where the fan pitch mechanism is configured to provide reverse pitch, reverse thrust can be provided, without the requirement for further thrust reverser arrangements. Consequently, reverse thrust, fan operating margin control and differential engine thrust can be achieved using a single actuator mechanism.

The engine core may be located between the first and second fans. The engine core may comprise a core inlet configured to receive free stream air from between the first and second fans.

The engine core may comprise a low pressure compressor, which may comprise either the first or the second compressor. The low pressure compressor may be coupled to the fan drive turbine by a low pressure shaft. The engine core may further comprise a high pressure turbine which may be coupled to a high pressure compressor by a high pressure shaft, which is independently rotatable relative to the low pressure shaft. The high pressure compressor may comprise one or more axial compressor stages upstream in core flow of one or more centrifugal compressor stages. The high pressure turbine may comprise a two-stage turbine.

The low pressure compressor may be provided axially forwardly of the low pressure turbine, and may be provided axially forwardly of the gearbox.

Alternatively, the low pressure turbine may be provided axially rearward of the high pressure compressor. The core inlet may be provided downstream of one or both fans, configured to ingest fan air, and may be provided at a downstream end of a fan nacelle. Advantageously, the core inlet provides boundary layer ingestion, thereby reducing nacelle drag. Nacelle drag may be particularly large in the case of a two-fan arrangement, since the nacelle surface area / fan area ratio is increased relative to single fan or coaxial fan arrangements.

The gas turbine engine may comprise a compressor intercooler arrangement configured to cool compressed air from an outlet of the low pressure compressor upstream in core air flow of an inlet of the high pressure compressor. The intercooler arrangement may comprise a compressed air duct extending between the low pressure compressor outlet and the high pressure compressor inlet. The intercooler arrangement may further comprise a cooling air duct configured to exchange heat between cooling air within the cooling duct, and compressor air within the compressed air duct.

The cooling air duct may comprise an inlet configured to ingest freestream air. Alternatively, the cooling air duct may comprise an inlet configured to ingest fan air, downstream of either the first or second fan. The cooling air duct may comprise a flow modulation valve configured to modulate air mass flow through the cooling air duct. Advantageously, where the cooling air duct inlet is configured to ingest fan air flow, and a modulating valve is provided, intercooling can be controlled, whilst simultaneously controlling effective fan outlet area using the same valve. Consequently, fan pressure ratio can be controlled, thereby preventing fan flutter, whilst also controlling the temperature of air delivered to the high pressure compressor. It has been found that at high engine thrust settings at low altitude (for example at takeoff), high intercooling (i.e. a large reduction in compressor air temperature) is required, to control high pressure compressor delivery temperatures. Simultaneously, high fan outlet areas are required to control fan flutter. Consequently, the same valve setting can beneficially affect both parameters. On the other hand, at high altitude, lower thrust conditions, intercooling can be reduced, since lower atmospheric temperature allows higher compressor pressure rise without resulting in higher compressor delivery temperatures, whereas a reduced fan outlet area may increase fan efficiency. Consequently, core temperature control and fan efficiency can be advantageously controlled using a single actuator.

The cooling air duct may comprise a first inlet configured to ingest freestream air and a second inlet configured to ingest fan air, the cooling air duct comprising a valve configured to modulate airflow from the first inlet and the second inlet. Consequently, intercooler airflow can be maintained for maximum core thermal efficiency, while controlling fan outlet flow for maximum fan efficiency.

The gas turbine engine may further comprise a recuperator arrangement configured to exchange heat between air exhausted from the fan drive turbine and air exiting the first or second compressor prior to entering the combustor. The gas turbine engine may comprise an exhaust duct configured to redirect forward flowing exhaust air from the fan drive turbine to a rearward direction.

The recuperator arrangement may comprise a recuperator compressor air duct in thermal contact with a fan drive turbine exhaust duct. The fan drive turbine exhaust duct may be configured to duct fan drive turbine exhaust flow in a rearward direction, and the recuperator compressor air duct may be configured to duct compressor air in a forward direction. Consequently, a reverse flow heat exchange arrangement is provided, which maximises heat transfer in a space efficient manner.

According to a second aspect of the present invention there is provided an aircraft comprising a gas turbine engine in accordance with the first aspect of the invention.

The first and second propulsors of the gas turbine engine may be located underneath a wing of the aircraft. The core inlet may be provided within the aircraft wing.

The core inlet may be configured to ingest air adjacent a trailing edge of the wing, adjacent an upper wing surface.

Alternatively, the core may be located underneath the wing.

The core may be mounted to a fuselage of the aircraft, and may be mounted at an aft portion of the aircraft adjacent an empennage. The core may be located at an upper surface of the fuselage, with the first and second fans being located at port and starboard sides of the fuselage respectively.

### BRIEF DESCRIPTION OF THE DRAWINGS

FIG. 1 shows a prior gas turbine engine;

FIG. 2 shows a perspective view from above and to the side from a forward end of a first gas turbine engine in accordance with the present disclosure;

FIG. 3 shows a cross sectional top view of the gas turbine engine of FIG. 2;

FIG. 4 shows a cross sectional side view of the gas turbine engine of FIG. 2;

FIG. 5 shows a schematic view of the gas turbine engine of FIG. 2;

FIG. 6 shows a schematic view of a second gas turbine engine in accordance with the present disclosure;

FIG. 7 shows a schematic view of a third gas turbine engine in accordance with the present disclosure;

FIG. 8 shows a schematic view of a fourth gas turbine engine in accordance with the present disclosure

FIG. 9 shows a schematic view of a fifth gas turbine engine in accordance with the present disclosure;

FIG. 10 shows a schematic view of a sixth gas turbine engine in accordance with the present disclosure;

FIG. 11 shows a schematic view of a seventh gas turbine engine in accordance with the present disclosure;

FIG. 12 shows a schematic front cross sectional view of part of an aircraft having the gas turbine engine of FIG. 2;

FIG. 13 shows a perspective side view from above and from a forward end of part of the aircraft of FIG. 12;

FIG. 14 shows a perspective side view from above and from a forward end of part of an aircraft having the engine of FIG. 11;

FIG. 15 shows a perspective side view from above and from a forward end of part of an aircraft having an engine installation of an eighth gas turbine engine;

FIG. 16 shows a perspective side view from above and from a forward end of part of an aircraft having an engine installation of a ninth gas turbine engine;

FIG. 17 shows a perspective side view from above and from a forward end of part of an aircraft having a still further alternative engine installation for an engine in accordance with any of FIGS. 2 to 11;

FIG. 18 shows a perspective side view from above and from a forward end of part of an aircraft having a tenth gas turbine engine in accordance with the present disclosure;

FIG. 19 shows a schematic side cross section view of part of an aircraft having the gas turbine engine of FIG. 6;

FIG. 20 shows an alternative gearbox arrangement for the gas turbine engine of any of FIGS. 2 to 11;

FIGS. 21a and 21b show an intercooler duct outlet of the gas turbine engine of FIGS. 2 to 5 in a closed position and an open position respectively;

FIG. 22 shows a schematic cross sectional side view of a recuperator of the gas turbine engine of FIG. 5;

FIG. 23 shows an axial cross section of the recuperator of FIG. 22;

FIG. 24 shows a perspective view from the front and the side of an eleventh gas turbine engine;

FIG. 25 shows a perspective view from the front and the side of the gas turbine engine of FIG. 7;

FIG. 26 shows a schematic view of the eleventh gas turbine engine of FIG. 24; and

FIG. 27 shows a schematic view of a twelfth gas turbine engine.

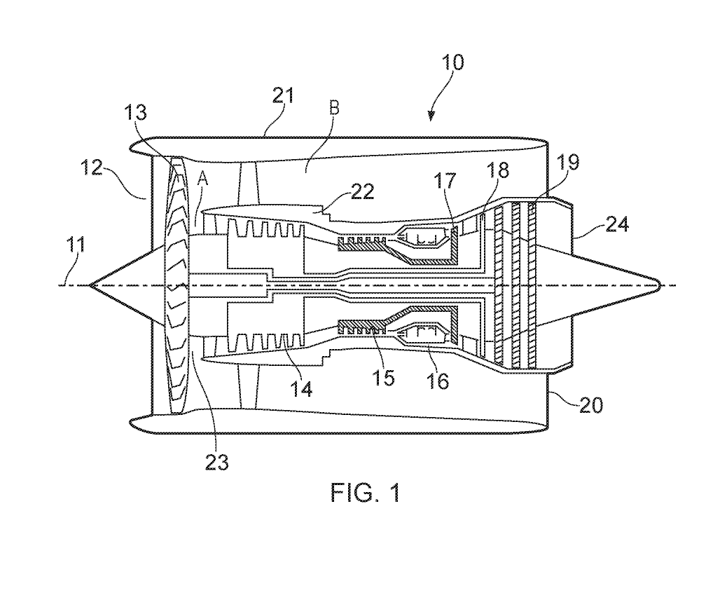

### DETAILED DESCRIPTION

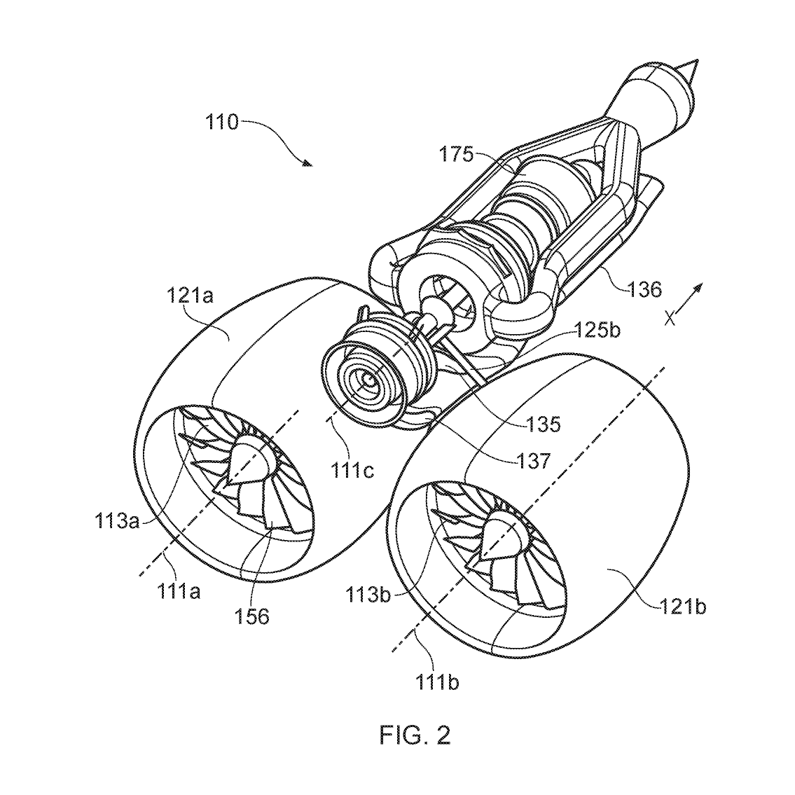

FIGS. 2, 3, 4 and 5 show a first gas turbine engine 110 in accordance with the present invention. The engine 110 comprises first and second ducted fans 113a, 113b provided within respective fan nacelles 121a and 121b. The fans 113a, 113b, and nacelles 121 are provided in a common plane, and rotate about parallel rotational axes 111a, 111b, but are non-coaxial, i.e. they do not occupy the same rotational axis. Alternatively, the fans 113a, 113b could be provided at different axial positions, or could be canted relative to one another.

Each fan 113a, 113b provides a propulsive air flow B which flows in an axial direction X, which defines a rearward direction. A forward direction is defined by an axial direction counter to this direction.

Each fan 113a, 113b comprises a plurality of fan blades 156. Each fan blade 156 is pivotable about a radially extending axis by a respective pitch change actuator 163a, 163b. The pitch change actuator may be of conventional construction, comprising for instance a hydraulic system similar to that used in variable pitch propellers. The actuator 163a, 163b is coupled to each fan blade, such that the blades 156 are pivoted together, such that the fan pitch can be altered. A separate pitch change actuator is provided for each fan 113a, 113b.

The engine 110 further comprises an engine core 175. Referring to FIG. 5, the core 175 comprises a first core module 190 comprising a first compressor in the form of a high pressure compressor 129 and a first turbine in the form of a high pressure turbine 131 interconnected by a first shaft in the form of a high pressure shaft 177. The core 175 further comprises a second core module 191 comprising a second compressor in the form of a low pressure compressor 128 and a fan drive turbine 143 interconnected by a second shaft in the form of a low pressure shaft 127. The first and second modules 190, 191 are separated in an axial direction X. In this embodiment, each component of the first module 190 is provided rearwardly of each component of the second module 191. Consequently, though the shafts 127, 177 rotate about a common engine axis 111c, the shafts do not overlap in an axial direction.

The core 175 defines a core airflow path A. Each fan 113a, 113b is driven by a fan drive turbine (described in further detail below) via a fan drive coupling. The fan drive coupling comprises respective first and second output shafts 125a, 125b. Each output shaft 125a, 125b is coupled to the respective fan via a respective output bevel drive 139a, 139b (shown schematically in FIG. 5), and at an opposite end is coupled to a gearbox 126. The gearbox 126 is driven by an input shaft 127, and is configured to receive input power from the input shaft 127, and drive the output shafts 125a, 125b at a lower rotational speed than the input shaft 127. The gearbox comprises a first toothed gear wheel in form of an input bevel gear 188 coupled to the input shaft 127. The teeth of the input bevel gear 188 are operably mated to teeth of first and second toothed gears in the form of output bevel gears 181a, 181b, which are in turn coupled to respective first and second output shafts 125a, 125b. The input shaft 127 rotates about a third rotational axis 111c, corresponding to a core rotational axis. The output shafts 125a, 125b have rotational axes substantially normal to the input shaft rotational axis 111c, with the output shafts 125a, 125b being provided in a common radial plane defining an approximately 90° angle relative to one another. It would be understood though that the output shafts 125a, 125b could be provided at a different angle, depending on the diameter of the engines, their distance from the engine core, and the required spacing between the nacelles 121.

The gearbox 126 and bevel drive 139a, 139b are together configured to provide a reduction ratio, such that the ratio between the input shaft 127 rotational speed and the fan 113a, 113b rotational speeds is approximately 4:1. The gearbox 126 may comprise further toothed gear wheels, and may comprise a planetary or star gearbox configuration. Alternatively, the gearbox may comprise a differential drive, or a continuously variable transmission or belt drive.

The input shaft 127 is driven by a common gas turbine engine core comprising at least one fan drive turbine, at least one compressor, and at least one combustor. In this first embodiment, the gas turbine engine core comprises the low pressure compressor 128, high pressure compressor 129, a combustor 130, the high pressure turbine 131 and the low pressure fan drive turbine 143.

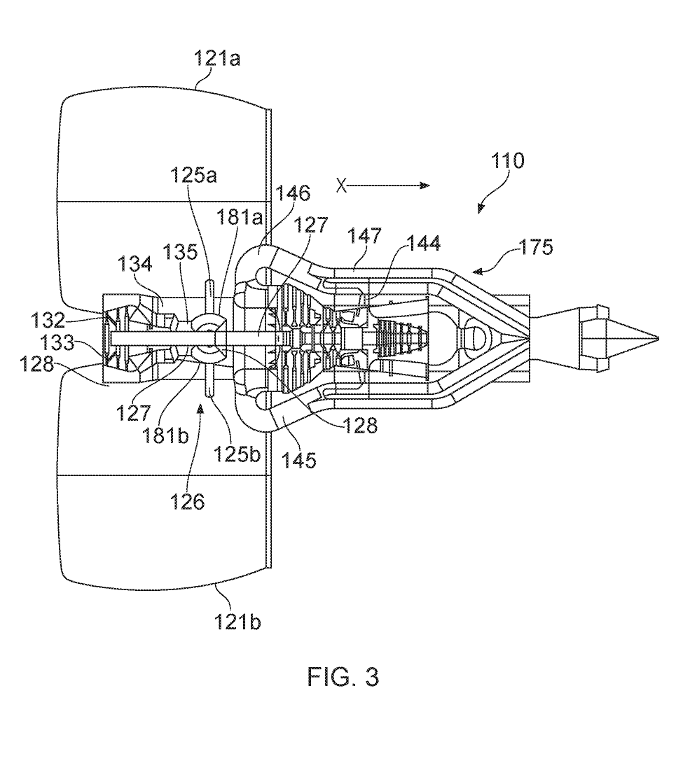

Referring to FIG. 3, the low pressure compressor 128 comprises a multi-stage axial flow compressor comprising three stages, each stage comprising a respective compressor rotor 132 and stator (not shown). The low pressure compressor 128 is located axially forwardly of the gearbox 126, and defines a core inlet 133 at an axially forward end. The low pressure compressor 128 is driven by the input shaft 127, or possibly a separate shaft which is driven at the same speed as the input shaft. Air ingested into the core inlet 133 defines a core flow. In operation, the compressor 128 is configured to ingest air from the core inlet 133, compress the air, and urge the compressed air in a direction parallel to the axial direction X, i.e. rearwardly.

At a rearward end of the low pressure compressor 128 is a low pressure compressor outlet 134. Air from the low pressure compressor 128 is directed in operation to the low pressure compressor outlet 134, into an inter-compressor core air duct 135. The inter-compressor core air duct 135 extends rearwardly toward a rear end of the gas turbine engine core. Surrounding at least part of the inter-compressor core air duct 135 is an intercooler duct 136. The intercooler duct 136 comprises a hollow passage having an inlet 137 at a forward end configured to ingest freestream air from between the first and second fan nacelles 121a, 121b to define an intercooler airflow C. Consequently, air flow within the intercooler duct 136 and air flow within the inter-compressor duct 135 flow in parallel, and are in thermal contact through the walls of the inter-compressor duct 135. In view of the temperature difference between the high temperature compressed air within the inter-compressor duct 135 and low temperature ambient air within the intercooler duct 137, heat is exchanged from the compressed air to the ambient air. Consequently, the intercooler duct 136 and inter-compressor core air duct 135 together form a compressor intercooler 157, thereby reducing the work required by further compressor stages, and increasing thermal efficiency.

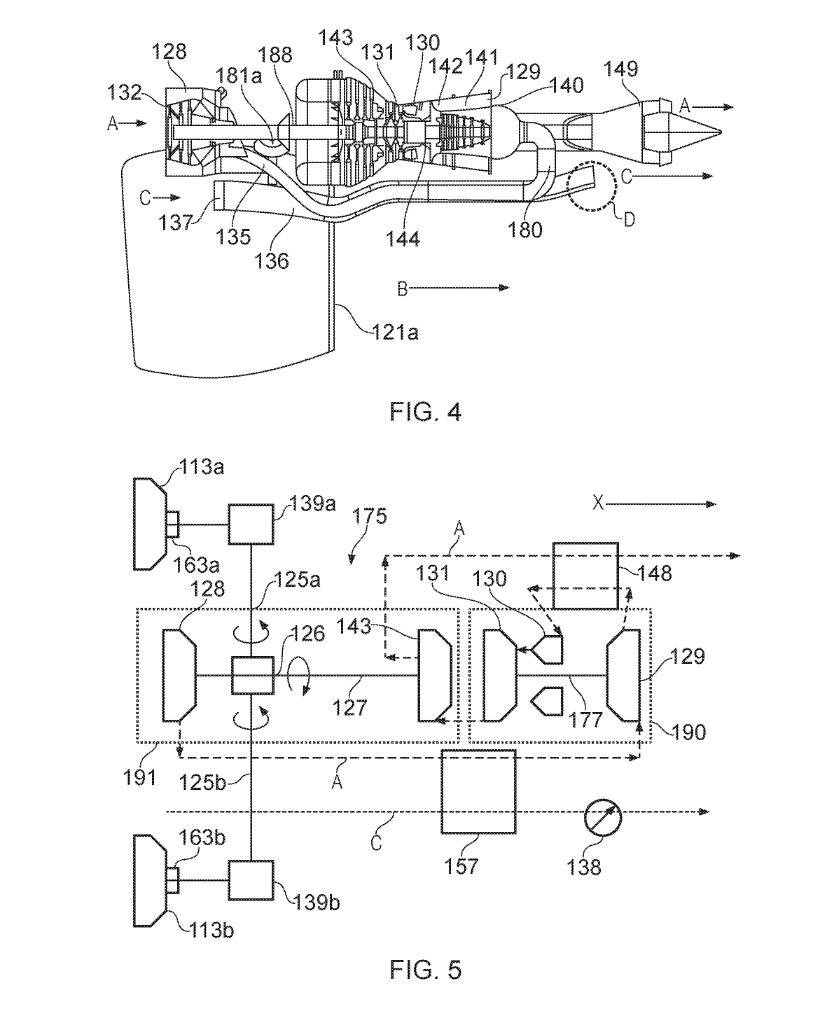

The intercooler duct 137 further comprises an intercooler cooling flow modulation valve 138 configured to modulate airflow C mass flow rate. FIGS. 21a and 21b show a cross section of the region D of FIG. 4 in a closed and an open position respectively. As can be seen, the flow modulation valve 138 comprises an axially movable exhaust plug 162, which is moveable between a closed position (shown in FIG. 21a) and an open position (shown in FIG. 21b) by a valve actuator 163 in the form of a hydraulic ram. As will be understood, the plug 162 may be moveable to intermediate positions between the open and closed positions. When in the open position, the airflow C mass flow rate is relatively high, resulting in a large amount of compressor air intercooling. On the other hand, when in the closed position, the airflow C mass flow rate is relatively low, or is shut off completely, such that little or no compressor air intercooling is provided. Consequently, the degree of intercooling can be controlled.

The exhaust plug 162 is shaped such that, when in the closed position, the intercooler duct 136 and plug 162 form a continuous surface, which tapers in a rearward direction in a “boat tail” configuration. Consequently, the intercooler duct 136 and plug 162 provide minimal drag when in the closed position. Similarly, a front surface 164 is angled downwardly, such that the plug provides minimal drag when in the open position. The shape of the plug 162 may be such that it uses the Coanda effect to redirect airflow C back towards a rearward direction.

The inter-compressor duct 135 comprises an elbow 180 at a rearward, downstream in core flow A end, which redirects core flow A at the downstream end by substantially 180° to a forward direction. The core flow A is thereby directed in operation into an inlet 140 of the high pressure compressor 129.

The high pressure compressor 129 comprises a plurality of axial compressor stages 141 at an axially rearward (i.e. upstream in core flow A) end thereof. Forwardly (i.e. downstream in core flow A) of the axial compressor stages 141 is a centrifugal impellor compressor 142. Together, the axial and centrifugal compressor stages 141, 142 further raise the pressure of the core air flow B in operation, and urge the core air flow B forwardly.

Downstream in core flow A is a recuperator compressor air passage 144, which extends generally radially outwardly from an outlet of the high pressure compressor 129. The recuperator compressor air passage 144 extends axially forwardly, before returning radially inwardly at a downstream end. The purpose of this passage will be described in further detail below.

Axially forwardly (i.e. downstream in core flow A) of the high pressure compressor 129 and downstream in core flow A from the recuperator compressor air passage 144 is the combustor 130, which is of conventional construction. In the combustor, fuel is provided and burnt with the compressed air in operation to increase the temperature of the core air flow A.

The high pressure turbine 131 is provided axially forwardly (i.e. downstream in core flow A) of the combustor. The high pressure turbine 131 comprises first and second stages, each comprising a respective rotor and stator. The high pressure turbine 131 directs flow forwardly, while extracting energy from the flow to drive a high pressure shaft 177, which is coupled to the high pressure compressor 129, to thereby drive the high pressure compressor 129 in operation.

Axially forwardly (i.e. downstream in core flow A) of the high pressure turbine 131 is the low pressure fan drive turbine 143, which is of similar construction to the high pressure turbine 131, comprising a plurality of rotors and stators, but generally comprises more stages than the high pressure turbine 131. The low pressure fan drive turbine is coupled to both the low pressure compressor 128 and the gearbox 126 via the input shaft 127. Consequently, the low pressure turbine 143 drives both the fans 113a, 113b and the low pressure compressor 128 via the shaft 127 in operation.

Axially forwardly (i.e. downstream in core flow A) of the low pressure turbine 143 is a core exhaust passage 145, which is configured to receive hot combustion products from a downstream end of the low pressure fan drive turbine 143 in the core air flow A. The core exhaust passage 145 comprises an elbow 146, which turns core air flow A approximately 180°, and so redirects air rearwardly in use.

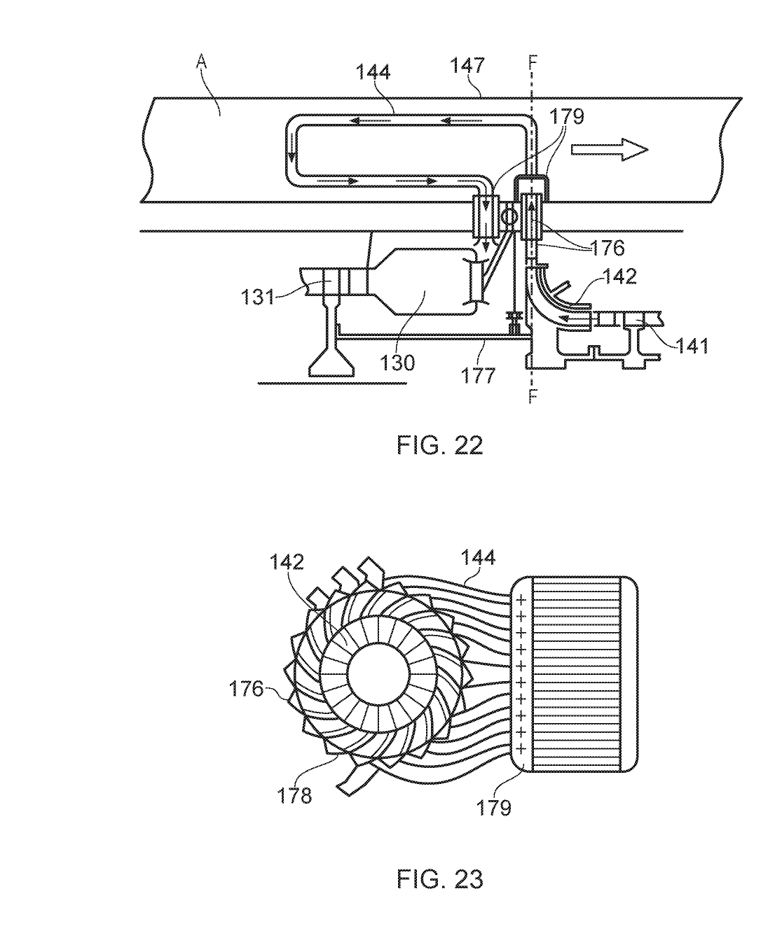

Downstream of the elbow 146 in core air flow A is a core exhaust recuperator passage 147, shown in more detail in FIG. 22. At least part of the core exhaust recuperator passage 147 encloses the recuperator compressor air passage 144, such that air within the respective passages 144, 147 is in thermal contact. The recuperator compressor air passage 144 extends in a radially outward direction from a diffuser 176 provided at an outlet of the high pressure compressor 129. The passage 144 extends forwardly through the passage, before turning 180°, and extending rearwardly. The passage may comprise further turns, to increase the length of passage within the core exhaust recuperator passage 147, to thereby increase the surface area in contact with exhaust air, and so increase heat exchange. The recuperator compressor air passage 144 then extends radially inwardly once more into an inlet of the combustor 130. Consequently, the passages 144, 147 together form a recuperator 148, since heat is exchanged in operation between exhaust flow and compressed air flow upstream of the combustor 130. Consequently, thermal efficiency is increased relative to prior arrangements.

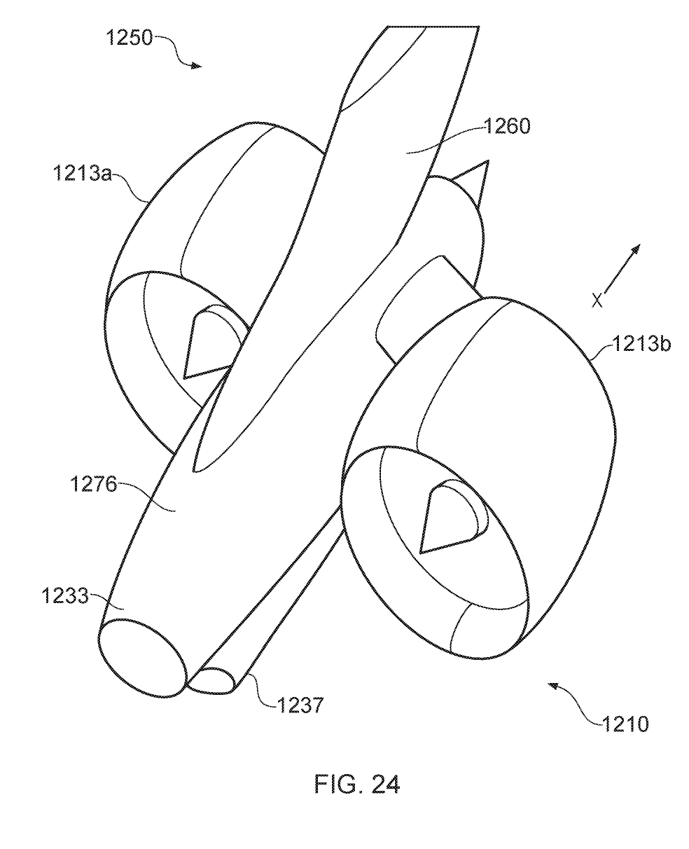

Referring to FIG. 23, a plurality of recuperator compressor air passages 144 are provided, which extend from the diffuser 176, circumferentially around the core axis. As shown in FIG. 23, a separate recuperator compressor air passage 144 is provided for each passage defined by adjacent diffuser vanes 178. Each compressor air passage 144 communicates with a heat exchanger inlet manifold 179, before emerging again as separate recuperator compressor air passages.

Downstream in core flow A and rearwardly of the core exhaust recuperator passage 147 is a core exhaust nozzle 149, which exhausts core air flow A into the ambient air flow.

Consequently, the above arrangement defines a “reverse flow” architecture, in which core flow A flows in a forward direction, i.e. in an opposite direction to the fan efflux, since at least one core turbine is provided forwardly of at least one core compressor. Both intercooling and recuperation can be provided by this arrangement, increasing thermal efficiency.

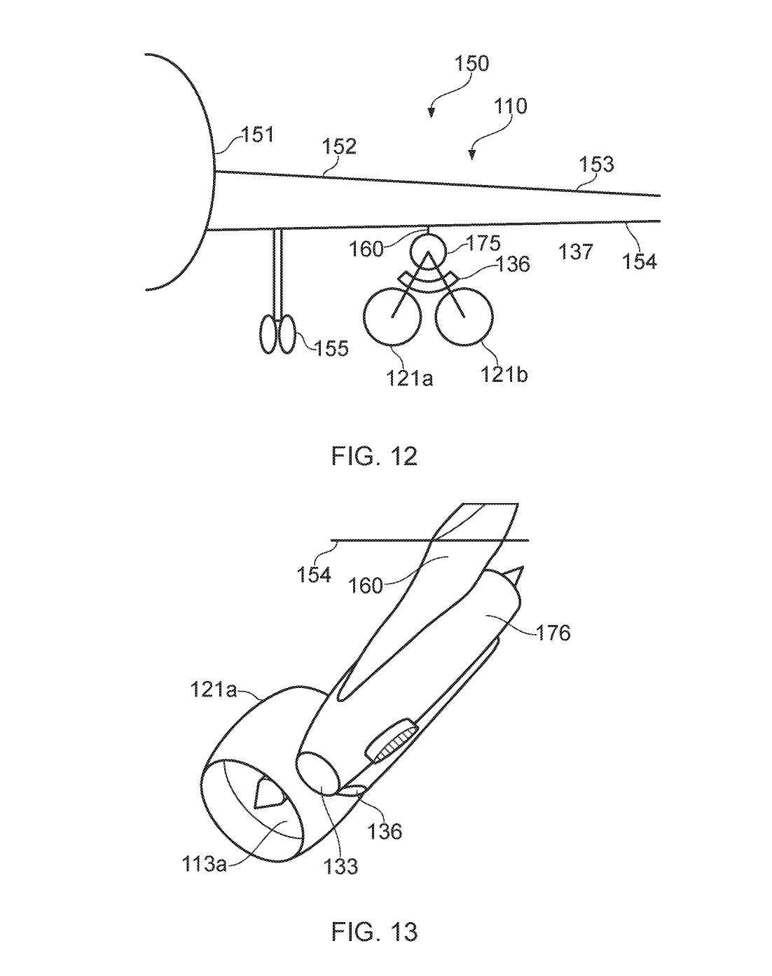

FIGS. 12 and 13 show the engine 110 installed on an aircraft 150. The aircraft 150 comprises a fuselage 151 and a pair of wings 152, one of which is shown in FIG. 12. The engine core axis 111c is below the wing 152, below a lower 154 surface. The core inlet 133 is provided

The core is located beneath the lower wing surface 154 on a pylon 160. The aircraft 150 is supported by wing mounted main landing gear 155. The landing gear 155 has a relatively short length, while providing sufficient ground clearance, in view of the relatively small diameter nacelles 121. Consequently, the weight of the landing gear can be reduced. This has further beneficial effects on aircraft having wing mounted landing gear, since landing gear weight reductions permit wing structural weight reductions, leading to further overall aircraft weight reductions. Furthermore, with the engine 110 located closer to the ground, maintenance of the engine 110 is simplified, since it can be reached more easily.

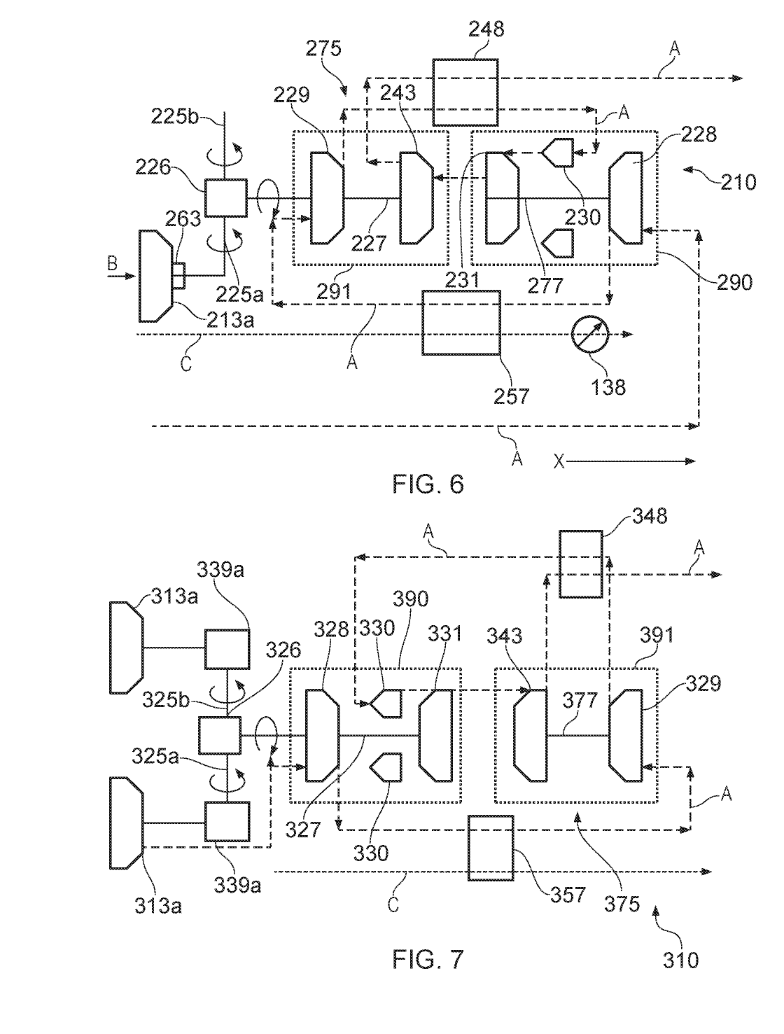

FIG. 6 provides a schematic illustration of a second gas turbine engine 210 in accordance with the present invention. The engine 210 comprises first and second fans (only one of which is shown in the drawing for clarity) of similar construction to the fans 113a, 113b of the engine 110. Each fan 213 is similarly driven by respective output shafts 225a, 225b which are in turn driven by a gearbox 226, which is in turn driven by an input shaft in the form of a fan drive turbine shaft 227. The gearbox 226 is again similar to the gearbox 126.

The fan drive turbine shaft 227 is driven by a core engine, having a different architecture from that of the engine 110. The engine 210 again comprising first and second core modules 290, 291. The first core module comprises a first compressor in the form of a low pressure compressor 228 and a first turbine in the form of a high pressure turbine 231 interconnected by a first shaft in the form of a high pressure shaft 277. The core 175 further comprises a second core module 291 comprising a second compressor in the form of a high pressure compressor 229 and a fan drive turbine 243 interconnected by a second shaft in the form of a low pressure shaft 227. The first and second modules 290, 291 are separated in an axial direction X. In this embodiment, each component of the first module 290 is provided rearwardly of each component of the second module 291. Again, though the shafts 227, 277 rotate about a common engine axis 111c, the shafts do not overlap in an axial direction.

The low pressure compressor 228 is configured to ingest a core air flow A. The inlet for the low pressure compressor 228 is located facing a rearward end of the engine, i.e. facing toward the axial direction X, parallel to the fan flow. Consequently, air flows into the compressor 228 in a forward direction, i.e. counter to the fan flow direction X. The low pressure compressor 228 is of conventional construction, and may comprise a centrifugal compressor, axial compressor, or may comprise both axial and centrifugal stages.

An outlet of the low pressure compressor 228 leads to a hot side of an intercooler heat exchanger 257. A cold side of the intercooler heat exchanger is provided with ambient air flow C. Consequently, the intercooler 257 cools the air compressed by the low pressure compressor 228, by exchanging heat by ambient temperature air.

Downstream in core flow (i.e. forwardly) of the intercooler 257 is a high pressure compressor 229, which may be of similar construction to the high pressure compressor 229 of the first embodiment. The high pressure compressor 229 is configured to compress the intercooled airflow A, and urge the airflow A rearwardly.

Downstream in core flow (i.e. rearwardly) of the high pressure compressor 229 outlet is a cold side of a recuperator heat exchanger 248. The recuperator heat exchanger is configured to raise the temperature of the core airflow A downstream of the high pressure compressor 229, and upstream of a combustor 230 by exchanging heat with the exhaust flow, similarly to the embodiment of FIGS. 2 to 5. The combustor 230 is provided downstream in core flow A (i.e. axially rearwardly) of the recuperator 248, and is again of conventional construction. The combustor 230 raises the temperature of core air flow A still further. The core flow A is redirected axially forwardly once again prior to flowing through the combustor 230. Alternatively, the combustor 230 could comprise a radial combustor 230, with the core airflow A flowing radially inwardly through the combustor 230 in use.

High and low pressure turbines 231, 243 are provided in series downstream of the combustor. In this region, the core airflow A is forward flowing. Again, the turbines are of similar construction to those of the first embodiment. Air flowing from an exhaust of the low pressure turbine 243 flows through a hot side of the recuperator heat exchanger 248, and out of an outlet (not shown).

Consequently, the gearbox 226 is provided at a forward end of the engine 210, with the high pressure compressor 229, low pressure turbine 243, high pressure turbine 231, combustor 230 and low pressure compressor 228 being provided in sequence extending rearwardly. However, the core air A is directed through the low pressure compressor 228, intercooler 257, high pressure compressor 229, combustor 230, high pressure turbine 231 low pressure turbine 243 and recuperator 248 in flow series.

The high pressure compressor 229, low pressure turbine 243 and gearbox 226 are interconnected by a low pressure fan drive shaft 227. The gearbox drives the output shafts 225a, 225b. A high pressure shaft 277 interconnects the low pressure compressor 228 and high pressure turbine 231. In view of this arrangement, the high pressure compressor rotates at the same speed as the gearbox input shaft and low pressure turbine. Similarly, the low pressure compressor rotates at the same speed as the high pressure turbine. However, the shafts are relatively short, which reduces weight.

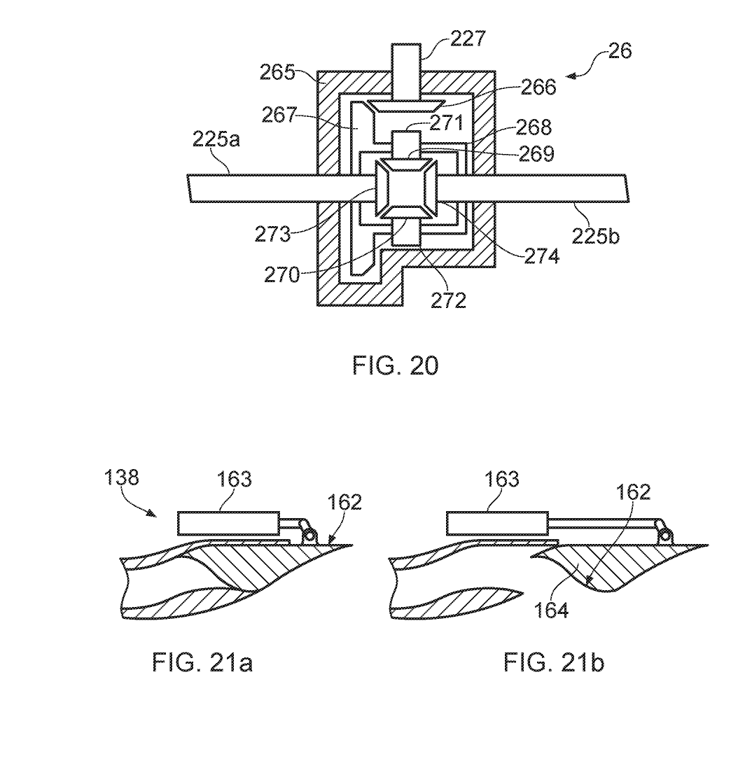

The gearbox 226 may be of similar construction to the gearbox 126. Alternatively, the gearbox 226 could comprise a differential gearbox 226 as shown in FIG. 20. The differential gearbox 226 is located within a housing 265 which encloses a first bevel gear 266, which is coupled to the fan drive turbine shaft 227. The input bevel gear 266 engages with a sun gear 267, which is configured to rotate about an axis normal to the axis of rotation of the bevel gear 266. The sun gear 267 is mounted on a planetary carrier 268, which mounts first and second planetary gears 269, 270 via respective shafts 271, 272. The planetary bevel gears 269, 270 are configured to rotate about their respective axes, which are generally parallel to the fan drive turbine shaft 227 axis, whilst also orbiting about the sun gear 267 axis. Each planetary bevel gear, 269, 270 engages against a respective output bevel gear 273, 274 located at opposite sides. Each output bevel gear 273, 274 is coupled to a respective first and second output shaft 225a, 225b.

Consequently, input torque from the fan drive turbine shaft 227 drives both output shafts 225a, 225b via the input, sun, planetary and output bevel gears 266, 267, 269, 270, 273, 274. In operation, the input bevel gear 266 drives the sun gear 267, which drives the planet carrier 268, and the planetary gears 269, 270 orbit about the sun gear axis. Where the load on each output shaft 225a, 225b is even, each planetary gear 269, 270 does not rotate about its respective axis, but only orbits, and so the output bevel gears 273, 274 are driven at equal speed, and the output torque is divided evenly between the output shafts 225a, 225b. On the other hand, where the load on the output shafts 225a, 225b are uneven, the output shaft having the lower load is driven at a higher rotational speed than the other output shaft, since the torque is still applied evenly.

As will be understood, the output load on each shaft 225a, 225b will be dependent on the aerodynamic loads on the fans 213. The aerodynamic loads on the fan will be a function of the fan pitch, fan rotational speed, and forward flight speed. The load can therefore be altered by adjusting one or more of these parameters.

In this embodiment, each fan 213 comprises a pitch change actuator 263 configured to collectively alter the pitch of the blades of the fan 213, and so adjust the angle of attack of the blades 213. In general, increasing the angle of attack of the blades will result in a higher load (i.e. a higher absorbed power), and so a higher torque for a given rotational speed. Since a differential will generally provide an equal torque to each output shaft, the speed of the fan having the higher load will be reduced. Consequently, by adjusting the pitch of a fan, the speed of that fan can be reduced relative to the other fan.

This effect can be beneficially employed for various applications. For example, the fan speed relative to the fan load can be adjusted, which may help control surge margin or flutter of a single fan. If the fan rotational speeds were fixed relative to one another, a reduction in speed of one fan would necessitate a reduction in speed of the other, which would be non-optimal, since inlet flows to each fan may be different in view of their different locations on the aircraft, and so the fans may have a different surge margin at given rotational speeds. Furthermore, this effect could be employed to rapidly adjust the thrust provided by each fan relative to the other, since fan thrust is related to fan rotational speed. Since the fans are non-coaxial, each fan may have a different lever arm relative to the aircraft. Consequently, increasing thrust on one engine alone may produce a pitch, yaw or roll force. Since pitch change can be actuated relatively quickly, such a system could be employed to provide additional aircraft control, thereby reducing the use of control surfaces, and minimising drag.

FIG. 19 shows a schematic side cross sectional view of an aircraft installation for the engine 210. The fans 213, 213 are provided within nacelles 221 located on pylons 260 provided underneath a lower side 254 of a wing 252, adjacent a leading edge 256. Since the low pressure compressor 228 is provided at the rear of the engine 210, an intake scoop 258 which provides air to the low pressure compressor 228 can be located adjacent a trailing edge 259, and can thereby be supplied with air from a rearward region of a wing upper surface 253, thereby energising the boundary layer thereon, and reducing airframe drag. Consequently, the fuel efficiency of the aircraft as a whole may be improved.

FIG. 7 shows a schematic illustration of a third gas turbine engine 310 in accordance with the present invention. Again, the engine 310 comprises first and second fans 313a, 313b of similar construction to the fans 113a, 113b of the engine 110. Each fan 313a, 313b is similarly driven by respective output shafts 325a, 325b which are in turn driven by a gearbox 326, which is in turn driven by an input shaft in the form of a fan drive turbine shaft 327. The gearbox 326 is again similar to the gearbox 126.

Again, the engine 310 comprises a core engine 376 which differs in this embodiment. The core engine 375 comprises first and second core modules 390, 391. The first core module 390 comprises a first compressor in the form of a low pressure compressor 328 and a first turbine in the form of a high pressure turbine 331 interconnected by a first shaft in the form of a high pressure shaft 327. The core 375 further comprises a second core module 391 comprising a second compressor in the form of a high pressure compressor 329 and a fan drive turbine 343 interconnected by a second shaft in the form of a low pressure shaft 327. The first and second modules 390, 391 are separated in an axial direction X. In this embodiment, each component of the first module 390 is provided forwardly of each component of the second module 391. Again, though the shafts 327, 377 rotate about a common engine axis, the shafts do not overlap in an axial direction.

The low pressure compressor 328 is provided axially rearwardly of the gearbox 326, and is configured to ingest fan air, i.e. air directly downstream of the fan 313a, 313b from a forward direction, compress this air, and urge this in a rearward direction. Rearwardly, and downstream in core flow A, is an intercooler 357 of similar construction to the previous embodiments, which is arranged to cool compressed air using freestream airflow C. Downstream of the intercooler 357 is the high pressure compressor 329, which further compresses the air, and redirects the air forwardly. This compressed air is then passed through a recuperator heat exchanger 348 which further heats the air using exhaust gas heat as in previous embodiments, before being passed to a combustor 330. Prior to entry to the combustor, the core flow A is again redirected rearwardly. After passing through the combustor in a rearward direction, the core flow A is passed rearwardly through the high and low pressure turbines 331, 343 in series, before passing through the hot side of the recuperator 348. The low pressure compressor 328, high pressure turbine 331 and gearbox 326 are interconnected by a fan drive shaft 327. The gearbox drives the output shafts 325a, 325b.

Consequently, the gearbox 326 is provided at a forward end of the engine 310, with the low pressure compressor 328, combustor 330, high pressure turbine 331, low pressure turbine 343, and high pressure compressor 229 being provided in sequence extending rearwardly. However, the core air A is directed through the low pressure compressor 328, intercooler 357, high pressure compressor 329, combustor 330, high pressure turbine 331 low pressure turbine 343 and recuperator 348 in flow series.

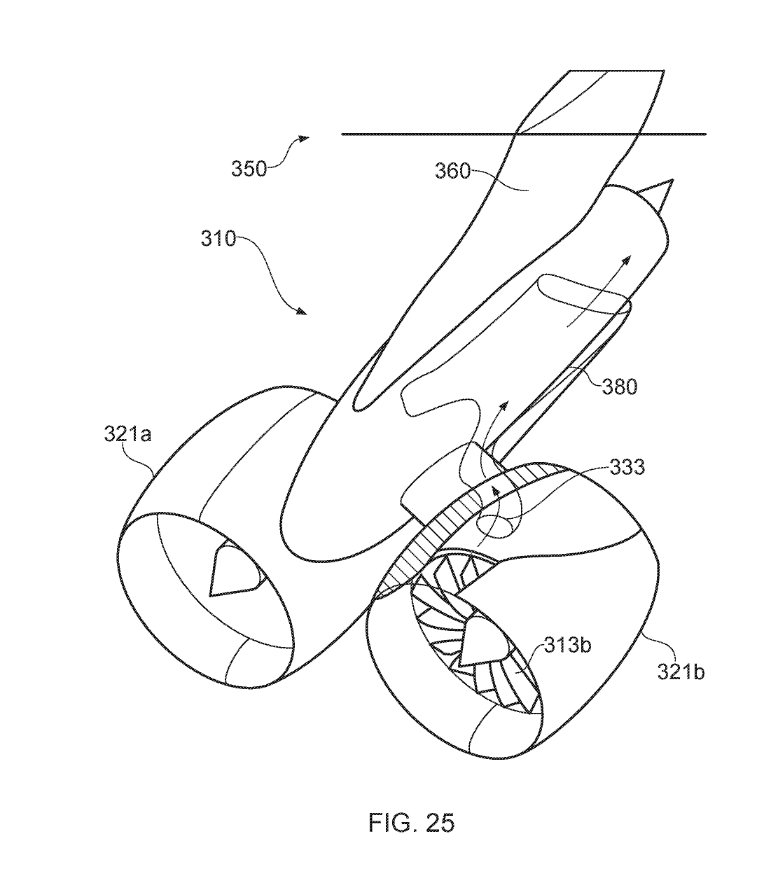

FIG. 25 is a perspective illustration of part of an aircraft 350 comprising the engine 310. As can be seen, a combined core and intercooler inlet 333 is provided within the nacelle 321b. A further core inlet (not shown) is provided in the nacelle 321a downstream of the fan 313b. The core inlets 333 from both nacelles 321a, 321b combine to form a core inlet passage 380, which communicates with the low pressure compressor 328. The intercooler 357 also communicates with the core inlet passage 380. Consequently, high pressure fan air provides both the core and intercooler flows A, C. In general, the inlet is arranged such that air is fed into the core prior to being heated by the intercooler. Advantageously, such an arrangement increases the overall pressure ratio (OPR) of the core, and so increases thermal efficiency. The effect on the intercooler effectiveness may vary depending on the details of the arrangement, since the mass flow will be increased (thereby increasing heat exchange), while cold stream temperature will be increased (thereby reducing heat exchange).

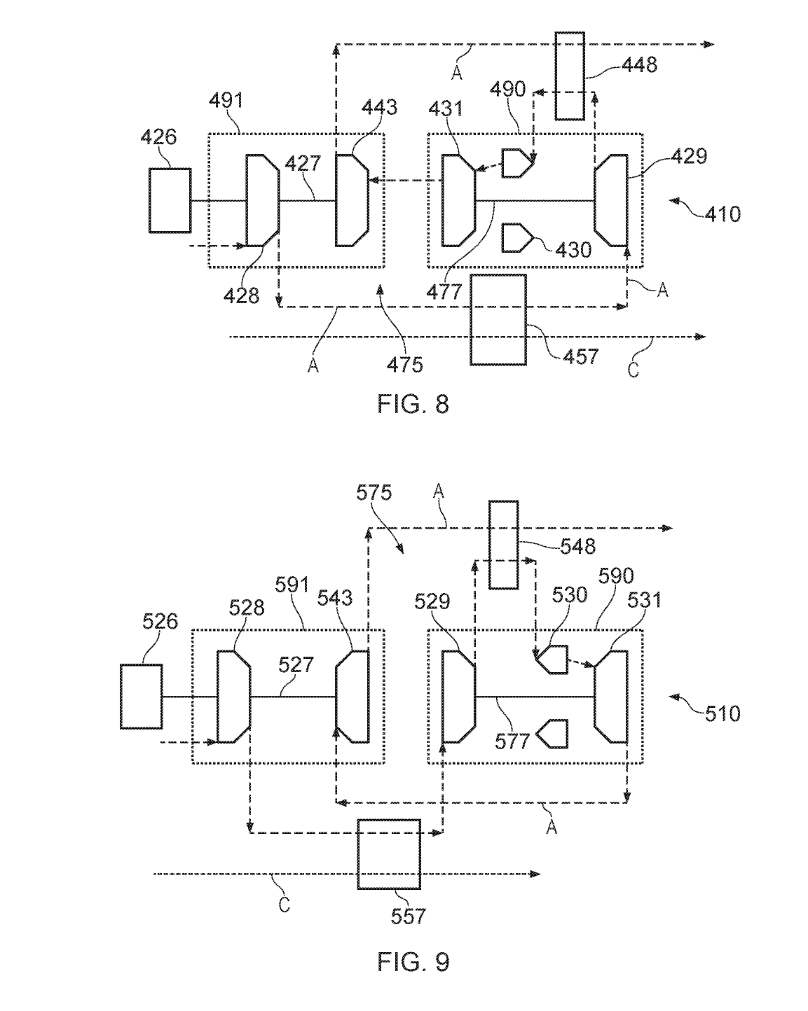

FIG. 8 shows a schematic illustration of a fourth gas turbine engine 410 in accordance with the present invention. Again, the engine 410 comprises first and second fans (omitted in the drawing for clarity) of similar construction to the fans 113a, 113b of the engine 110. Each fan is similarly driven by respective output shafts (not shown) which are in turn driven by a gearbox 426, which is in turn driven by an input shaft in the form of a fan drive turbine shaft 427. The gearbox 426 is again similar to the gearbox 126.

The engine 410 comprises a core engine 475 having first and second core modules 490, 491. The first core module 490 comprises a first compressor in the form of a high pressure compressor 429 and a first turbine in the form of a high pressure turbine 431 interconnected by a first shaft in the form of a high pressure shaft 477. The core 475 further comprises a second core module 491 comprising a second compressor in the form of a low pressure compressor 428 and a fan drive turbine 443 interconnected by a second shaft in the form of a low pressure shaft 427. The first and second modules 490, 491 are separated in an axial direction X. In this embodiment, each component of the first module 490 is provided rearwardly of each component of the second module 491. Again, though the shafts 427, 477 rotate about a common engine axis, the shafts do not overlap in an axial direction.

The low pressure compressor 428 is provided axially rearwardly of the gearbox 426, and is configured to ingest freestream air from a forward direction, compress this air, and urge this in a rearward direction. Rearwardly, and downstream in core flow A, is an intercooler 457 of similar construction to the previous embodiments, which is arranged to cool compressed air using freestream airflow C. Downstream of the intercooler 457 is the high pressure compressor 429, which further compresses the air, and redirects the air forwardly. This compressed air is then passed through a recuperator heat exchanger 448 which further heats the air using exhaust gas heat as in previous embodiments, before being passed to a combustor 430. Air flows forwardly through the combustor 430, before being passed forwardly through the high and low pressure turbines 431, 443 in series, before then passing through the hot side of the recuperator 448. Again, the low pressure compressor 428, low pressure turbine 443 and gearbox 426 are interconnected by a low pressure fan drive shaft 427. The gearbox drives the output shafts.

Consequently, the gearbox 426 is provided at a forward end of the engine 410, with the low pressure compressor 428, low pressure turbine 443, high pressure turbine 431, combustor 430, and high pressure compressor 429, being provided in sequence extending rearwardly. However, the core air A is directed through the low pressure compressor 428, intercooler 457, high pressure compressor 429, combustor 430, high pressure turbine 431 low pressure turbine 443 and recuperator 448 in flow series. This arrangement provides a shorter shaft 427 between the low pressure compressor 428 and low pressure turbine 443. However, tighter turning of the airflow downstream of the low pressure compressor 428 is required in view of this.

FIG. 9 shows a schematic illustration of a fifth gas turbine engine 510 in accordance with the present invention. Again, the engine 510 comprises first and second fans (omitted in the drawing for clarity) of similar construction to the fans 113a, 113b of the engine 110. Each fan is similarly driven by respective output shafts (not shown) which are in turn driven by a gearbox 526, which is in turn driven by an input shaft in the form of a fan drive turbine shaft 527. The gearbox 526 is again similar to the gearbox 126.

The engine 510 comprises a core engine 575 having first and second core modules 590, 591. The first core module 590 comprises a first compressor in the form of a high pressure compressor 529 and a first turbine in the form of a high pressure turbine 531 interconnected by a first shaft in the form of a high pressure shaft 577. The core 575 further comprises a second core module 591 comprising a second compressor in the form of a low pressure compressor 528 and a fan drive turbine 543 interconnected by a second shaft in the form of a low pressure shaft 527. The first and second modules 590, 591 are separated in an axial direction X. In this embodiment, each component of the first module 590 is provided rearwardly of each component of the second module 591. Again, though the shafts 527, 577 rotate about a common engine axis, the shafts do not overlap in an axial direction.

Again, the core engine arrangement differs in this embodiment. The low pressure compressor 528 is provided axially rearwardly of the gearbox 526, and is configured to ingest freestream air from a forward direction, compress this air, and urge this in a rearward direction. Rearwardly, and downstream in core flow A, is an intercooler 557 of similar construction to the previous embodiments, which is arranged to cool compressed air using freestream airflow C. Downstream of the intercooler 557 is the high pressure compressor 529, which further compresses the air, and directs the air rearwardly through a recuperator heat exchanger 548 which further heats the air using exhaust gas heat as in previous embodiments, before being passed to a combustor 530. Air continues to flow rearwardly through the combustor 530, before being passed further rearwardly through a high pressure turbine 531. Downstream of the high pressure turbine 531, the core airflow A is redirected forwardly to the low pressure fan drive turbine 543 situated axially between the high pressure compressor 529 and low pressure compressor 528. Air exhausted from the low pressure turbine is passed through a hot side of the recuperator 548, thereby heating compressor air prior to entry into the combustor 530. The gearbox 526 drives the output shafts.

Consequently, the gearbox 526 is provided at a forward end of the engine 510, with the low pressure compressor 528, low pressure turbine 543, high pressure compressor 529, combustor 530, and high pressure turbine 531, being provided in sequence extending rearwardly. However, the core air A is directed through the low pressure compressor 528, intercooler 557, high pressure compressor 529, combustor 530, high pressure turbine 531 low pressure turbine 543 and recuperator 548 in flow series.

As can be seen from FIG. 9, in this arrangement, the high pressure turbine 529 and compressor 531 are situated adjacent one another, with the low pressure turbine 543 and compressor 528 being situated adjacent one another forwardly thereof. Consequently, the shafts 527, 577 do not have to pass through one another, and can be relatively short. Furthermore, the ducting between the low pressure compressor 528 and high pressure compressor 529 is shorter, resulting in lower flow losses, and lower weight. Furthermore, the low pressure compressor 528 and turbine 543 are interconnected, as are the high pressure compressor 529 and high pressure turbine 531. Consequently, the speeds of these components can be matched. On the other hand, hot high pressure turbine exhaust gasses must be redirected forwardly, and run the length of the high pressure engine core (i.e. the compressor 129, combustor 520 and turbine 531) and the length of the low pressure turbine 543, before running rearwardly again.

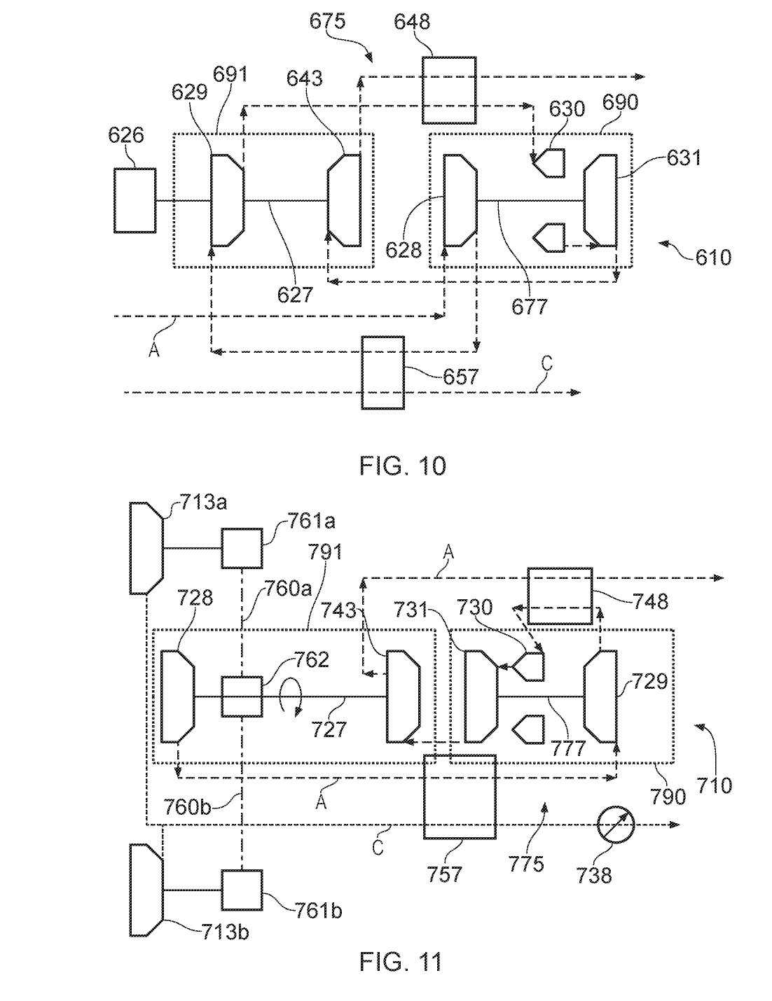

FIG. 10 shows a schematic illustration of a sixth gas turbine engine 610 in accordance with the present invention. Again, the engine 610 comprises first and second fans (omitted in the drawing for clarity) of similar construction to the fans 113a, 113b of the engine 110. Each fan is similarly driven by respective output shafts (not shown) which are in turn driven by a gearbox 626, which is in turn driven by an input shaft in the form of a fan drive turbine shaft 627. The gearbox 626 is again similar to the gearbox 126.

The engine 610 comprises a core engine 675 having first and second core modules 690, 691. The first core module 690 comprises a first compressor in the form of a low pressure compressor 628 and a first turbine in the form of a high pressure turbine 631 interconnected by a first shaft in the form of a high pressure shaft 677. The core 675 further comprises a second core module 691 comprising a second compressor in the form of a high pressure compressor 629 and a fan drive turbine 643 interconnected by a second shaft in the form of a low pressure shaft 627. The first and second modules 690, 691 are separated in an axial direction X. In this embodiment, each component of the first module 690 is provided rearwardly of each component of the second module 691. Again, though the shafts 627, 677 rotate about a common engine axis, the shafts do not overlap in an axial direction.

The low pressure compressor 628 is provided at a mid-section of the engine 610, axially rearwardly of the gearbox 626, the high pressure compressor 629, and the low pressure fan drive turbine 643, and is configured to ingest freestream air from a forward direction, compress this air, and urge this compressed air in a forward direction. Downstream in core flow A, is an intercooler 657 of similar construction to the previous embodiments, which is arranged to cool compressed air using freestream airflow C. Downstream of the intercooler 657 is the high pressure compressor 629, which further compresses the air, and directs the air rearwardly through a recuperator heat exchanger 648 which further heats the air using exhaust gas heat as in previous embodiments, before being passed to a combustor 630. Air continues to flow rearwardly through the combustor 630, before being passed further rearwardly through the high pressure turbine 631. Downstream of the high pressure turbine 531, the core airflow A is redirected forwardly to the low pressure fan drive turbine 643 situated axially between the high pressure compressor 629 and low pressure compressor 628. Air exhausted from the low pressure turbine 643 is turned rearwardly once more, before being passed through a hot side of the recuperator 648, thereby heating compressor air prior to entry into the combustor 630. The high pressure compressor 629, low pressure turbine 643 and gearbox 626 are interconnected by a fan drive shaft 627. The gearbox 626 drives the output shafts. A high pressure shaft 677 interconnects the low pressure compressor 628 and high pressure turbine 631.

Consequently, the gearbox 626 is provided at a forward end of the engine 610, with the high pressure compressor 629, low pressure turbine 643, low pressure compressor 628, combustor 630, and high pressure turbine 631, being provided in sequence extending rearwardly. However, the core air A is directed through the low pressure compressor 628, intercooler 657, high pressure compressor 629, combustor 630, high pressure turbine 631 low pressure turbine 643 and recuperator 648 in flow series.

As will be understood, the length between the high pressure compressor 629 exit and the combustor 630 are increased, thereby providing more surface area for heat exchange for the recuperator, thereby increasing its effectiveness. On the other hand, the complex airflow may result in flow losses.

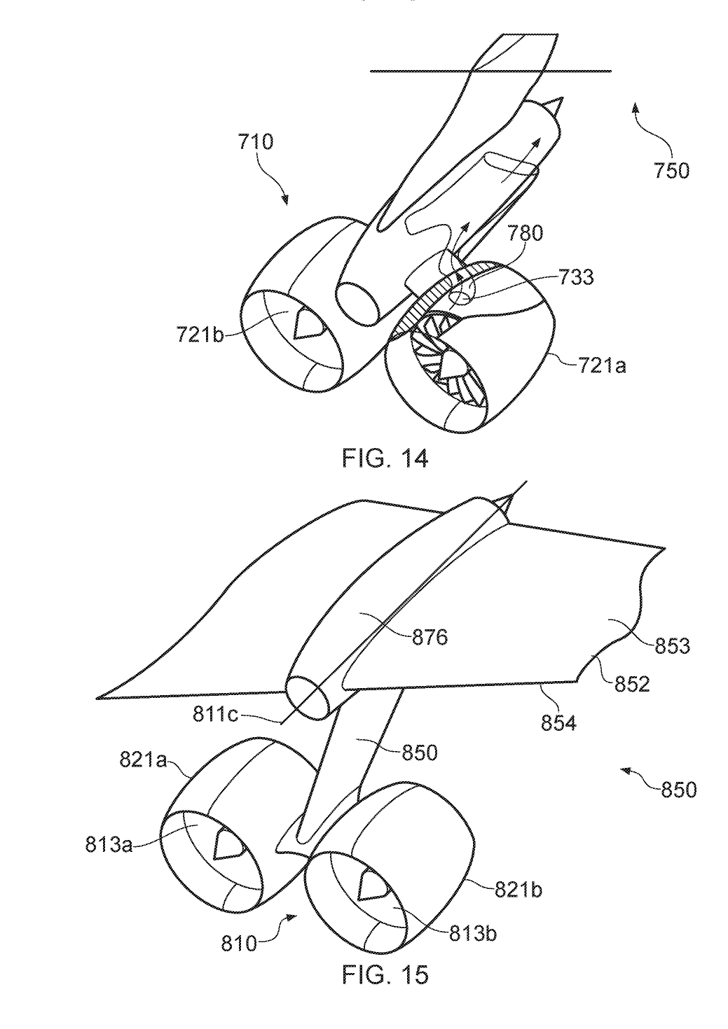

FIGS. 11 and 14 show a seventh gas turbine engine 710 in accordance with the present invention. The gas turbine engine 710 has a similar core architecture to that of the engine of FIGS. 2 to 5, but with a different fan drive coupling and with a different intercooler arrangement.

The engine 710 comprises a core engine 775 having first and second core modules 790, 791. The first core module 790 comprises a first compressor in the form of a high pressure compressor 729 and a first turbine in the form of a high pressure turbine 731 interconnected by a first shaft in the form of a high pressure shaft 777. The core 775 further comprises a second core module 791 comprising a second compressor in the form of a low pressure compressor 728 and a fan drive turbine 743 interconnected by a second shaft in the form of a low pressure shaft 727. The first and second modules 790, 791 are separated in an axial direction X. In this embodiment, each component of the first module 790 is provided rearwardly of each component of the second module 791. Again, though the shafts 727, 777 rotate about a common engine axis, the shafts do not overlap in an axial direction.

The low pressure compressor 728 is provided at a forward end of the engine 710, with the low pressure fan drive turbine 743, high pressure compressor, a combustor 730, and the high pressure compressor 729, being provided in sequence extending rearwardly. The engine 710 is configured such that core air A is directed through the low pressure compressor 728, high pressure compressor 729, combustor 730, high pressure turbine 731 low pressure turbine 743 and a recuperator 748 in flow series. A high pressure shaft 777 interconnects the high pressure compressor 729 and high pressure turbine 731, and a low pressure fan drive shaft 727 interconnects the low pressure compressor 728 and low pressure turbine 743.

The engine 710 is provided with an intercooler duct 780 configured to receive an intercooler cooling airflow C. The airflow C is provided from an intercooler duct inlet 733 located behind the fans 713a, 713b within the fan ducts 721a, 721b. The duct 736 comprises a valve 738 similar to the valve 138, which modulates flow through the intercooler duct 780. However, since the intercooler duct inlet 733 receives air from downstream of the fan 713a, modulation of cooling air flow through the duct 780 affect the fan pressure ratio (i.e. reducing flow by closing the valve 738 increases back pressure on the fan, thereby reducing fan pressure ratio, and vice versa). Consequently, the valve 738 can be modulated to control fan pressure ratio, thereby controlling fan surge margin.

The engine 710 comprises first and second fans 713a, 713b arranged similarly to the fans 113a, 113b of the first embodiment, and driven by the core by a fan drive coupling. However, the fan drive coupling of the engine 710 differs from that of the previously described embodiments.

The fan drive coupling comprises the fan drive shaft 727, which is coupled to, and thereby drives in use, an electrical generator 762. Optionally, the generator 762 could be driven by a gearbox, and could be located forward of the low pressure compressor 728. The electrical generator comprises a alternating current (AC) generator, and is electrically coupled to first and second electrical motors 761a, 761b via respective electrical interconnectors 760a, 760b. The electrical motors 761a, 761b are in turn coupled to respective fans 713a, 713b, and thereby drive them in use. Consequently, the fan drive turbine 727 drives the fans 713a, 713b via the generator 762, electrical interconnectors 760a, 760b and motors 761a, 761b. As will be understood, the pole numbers of the motors 761a, 761b can differ from those of the generator 762, thereby providing an effective reduction ratio between the fan drive shaft 727 and fans 713a, 713b. It will be understood that DC generators, motors and interconnectors could alternatively be used. Optionally, power electronics units (i.e. AC to AC converters) can be employed to control the electrical frequency of power provided to the electrical motors 761a, 761b, to thereby control speed of the electrical motors 761a, 761b, and therefore fans 713a, 713b independently of the other motor, and of the fan drive turbine 727 speed.

Any of the gas turbine engines 2 to 11 could be mounted to an aircraft in accordance with alternative installation configurations, as shown in FIGS. 15 to 17.

FIG. 15 shows an engine installation for an aircraft 850. The installation comprises a gas turbine engine 810, which has a similar core arrangement to any of the previously described engines, having a core 876 and a pair of fans 813a, 813b installed within respective nacelles 821a, 821b. However, in this instance, the core 876 is installed within the wing 852, such that a core rotational axis 811c extends between upper 853 and lower surfaces 854 of the wing 852. Consequently, core nacelle drag is minimised, as part of the core 876 is contained within the wing 852. The nacelles 821a, 821b meanwhile project from a pylon 850 when extends beneath the wing 852. A shaft may be provided within the wing interconnecting the gas turbine engine fan drive turbine (not shown) and a bevel gearbox provided between the engine nacelles 821a, 821b.

Alternatively, the engine 810 may comprise an electrical generator and electrical motors, similar to the embodiment shown in FIG. 11.

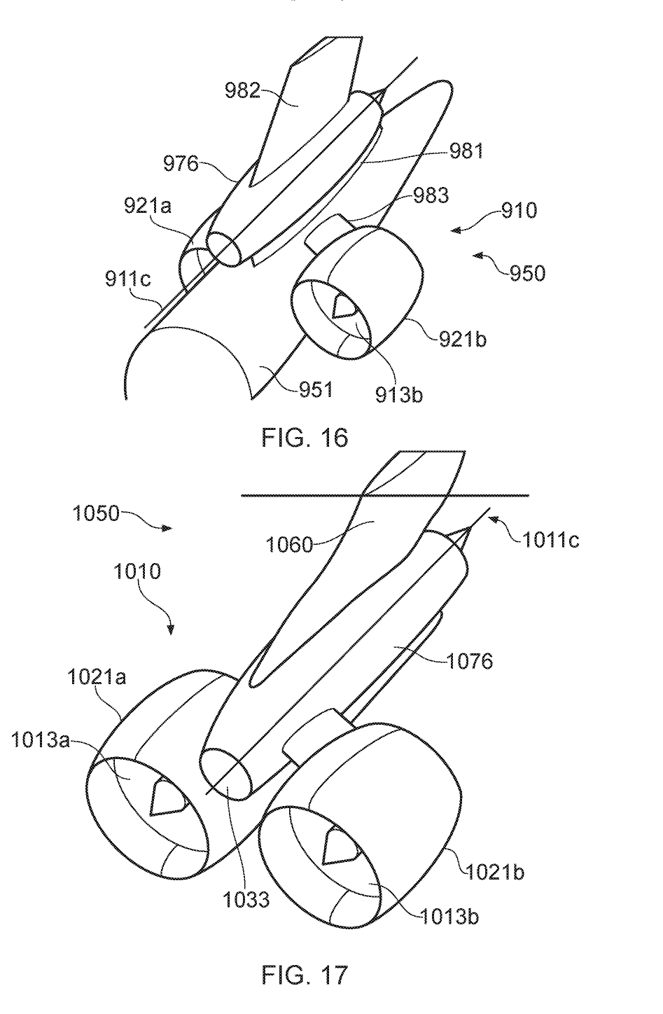

FIG. 16 shows an engine installation for an aircraft 950 comprising an engine 910. The engine 910 may be similar to any of the engines shown in FIGS. 2 to 11. In this embodiment, the engine 910 is mounted to an aft end of an aircraft fuselage 951, with an engine core 976 mounted to an upper surface of the fuselage 951 by a core pylon 981. The core pylon 981 forms a root portion of a vertical tail 982, which extends upwardly from the core 976.

The engine comprises a pair of fan nacelles 921a, 921b, which are located adjacent a respective side of the fuselage 951, below the core 976. Each nacelle 921a, 921b is mounted by a respective nacelle pylon 983, through which first and second output shafts (not shown) pass. Since only the core 976 is mounted to the tail, the structural penalties for this installation are relatively small. This installation may be provided in addition to an installation such as that shown in any of FIG. 12 to 15 or 17, such that an engine is provided underneath each wing, in addition to a fuselage mounted engine.

FIG. 17 shows an engine installation for an aircraft 1050 having an engine 1010, which again may comprise a core 1076 similar to any of the cores illustrating in FIGS. 2 to 11. In this instance, the gas turbine engine 1010 comprises a single core inlet/intercooler inlet 1033. In this case, the inlet coincides with the core engine rotational axis 1011c, and is configured to ingest free-stream air, and deliver this air to both a low pressure compressor and an intercooler duct (not shown). Consequently, the low pressure compressor and intercooler are both supplied with low temperature, undisturbed air.

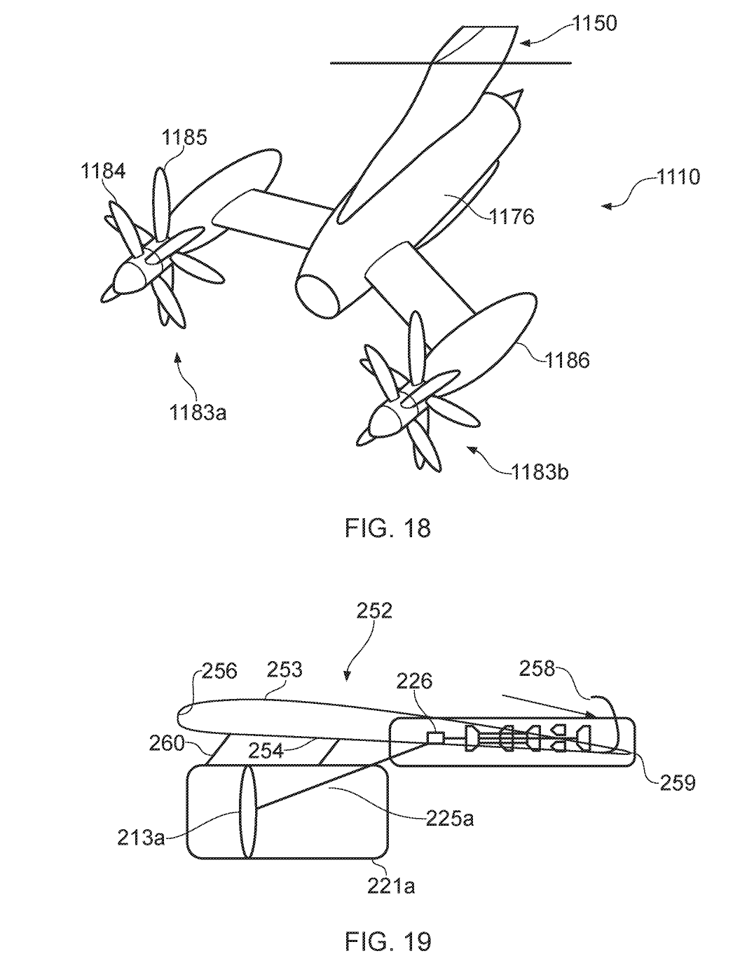

FIG. 18 shows a tenth gas turbine engine 1110 installed on an aircraft 1150. The engine 1110 comprises an engine core 1176 which is arranged in accordance with any of the architectures of the previous embodiments. However, in place of a fan, each fan drive turbine is coupled, via a gearbox, to a respective first and second propulsors in the form of open rotor propeller arrangements 1183. The propeller arrangements lack nacelles, instead being provided on a respective pod 1186. Each open rotor propeller arrangement comprises first and second coaxial contra-rotating propeller stages 1184, 1185, driven by a gearbox (not shown). Open rotors generally enable high bypass ratios, without the aerodynamic and weight disadvantages implied by the large diameter nacelle. However, the bypass ratio is generally limited by other considerations, such as ground clearance, noise of the high tip speed rotors, and safety considerations. Each of these problems is ameliorated by having a pair of rotors driven by a common gas turbine engine core.

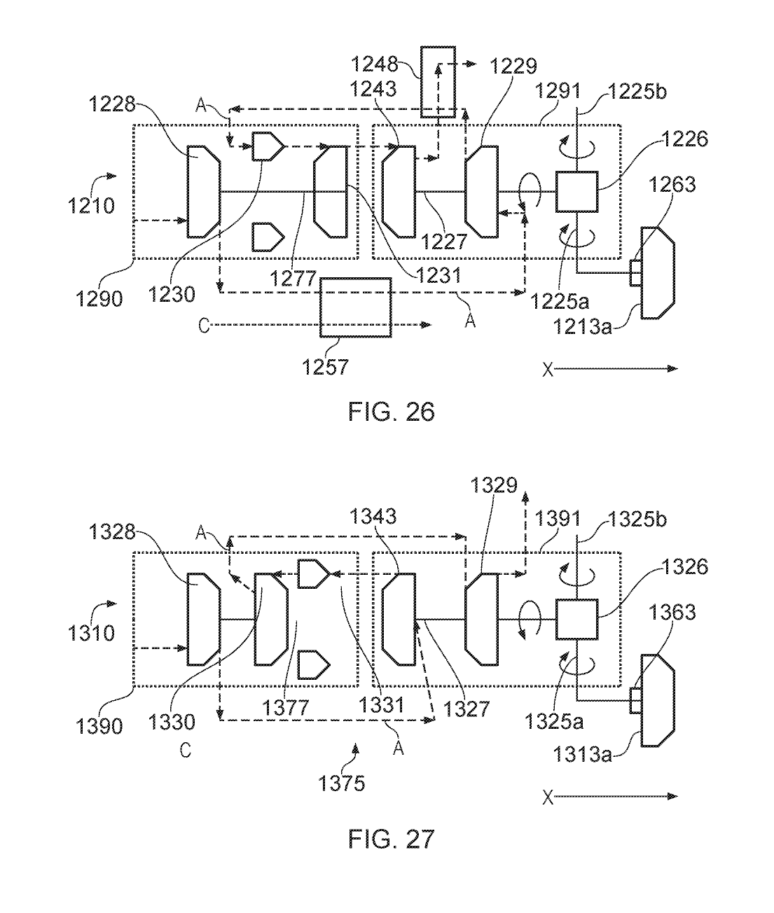

FIG. 24 shows an eleventh gas turbine engine 1210 installed on an aircraft 1250. The engine 1210 is arranged as shown in FIG. 26. The engine 1210 comprises first and second fans 1213 (only one of which is shown in FIG. 26 for clarity) of similar construction to the fans 113a, 113b of the engine 110. Each fan 1213 is similarly driven by respective output shafts 1225a, 1225b which are in turn driven by a gearbox 1226, which is in turn driven by an input shaft in the form of a fan drive turbine shaft 1227.

The gearbox 1226 is again similar to the gearbox 126. As can be seen in FIG. 24 in particular, the fans 1213, are located at a rearward end of the engine 1210, downstream of the gearbox 1226, and downstream of a core engine inlet 1233. Advantageously, the relatively heavy core can be mounted forwardly, which may help to damp any wing flutter.

The fan drive turbine shaft 1227 is driven by a core engine 1275 provided within a nacelle, the core engine 1276 having a different architecture from that of the previously described engines. Engine 1210 comprises a core engine 1275 having first and second core modules 1290, 1291. The first core module 1290 comprises a first compressor in the form of a low pressure compressor 1228 and a first turbine in the form of a high pressure turbine 1231 interconnected by a first shaft in the form of a high pressure shaft 1277. The core 1275 further comprises a second core module 1291 comprising a second compressor in the form of a high pressure compressor 1229 and a fan drive turbine 1243 interconnected by a second shaft in the form of a low pressure shaft 1227. The first and second modules 1290, 1291 are separated in an axial direction X. In this embodiment, each component of the first module 1290 is provided forwardly of each component of the second module 1291. Again, though the shafts 1227, 1277 rotate about a common engine axis, the shafts do not overlap in an axial direction.

The engine 1210 comprises a low pressure compressor 1228, which ingests a core air flow A. The core engine inlet 1233 for the low pressure compressor 1228 is located facing a forward end of the engine, i.e. facing oppositely to the axial direction X, and is located forwardly of the fans 1213a, 1213b. Consequently, air flows into the compressor 1228 in a rearward direction, and so no turning is required prior to the airflow entering the compressor 1228, which may improve efficiency and reduce overall engine length.

An outlet of the low pressure compressor 1228 leads to a hot side of an intercooler heat exchanger 1257. A cold side of the intercooler heat exchanger is provided with ambient air flow C from an intercooler inlet 1237. The intercooler inlet 1237 is configured to ingest freestream air, and is provided forwardly of the fans 1213a, 1213b. Consequently, the intercooler 1257 cools the air compressed by the low pressure compressor 1228, by exchanging heat by ambient temperature air. Downstream in core flow of the intercooler 1257 is a high pressure compressor 1229. The high pressure compressor 1229 is configured to compress the intercooled airflow A, and urge the airflow A forwardly.

Downstream in core flow of the high pressure compressor 1229 outlet is a cold side of a recuperator heat exchanger 1248, similar to those of the previous embodiments. The recuperator heat exchanger is configured to raise the temperature of the core airflow A downstream of the high pressure compressor 1229, and upstream of a combustor 1230 by exchanging heat with the exhaust flow. The combustor 1230 is provided downstream in core flow A of the recuperator 1248, and is again of conventional construction. The combustor 1230 raises the temperature of core air flow A still further. The core flow A is redirected axially rearwardly once again prior to flowing through the combustor 1230.

High and low pressure turbines 1231, 1243 are provided in series downstream of the combustor 1230. In this region, the core airflow A is generally rearwardly flowing. Air flowing from an exhaust of the low pressure turbine 1243 flows through a hot side of the recuperator heat exchanger 1248, and out of an outlet (not shown).

Consequently, the gearbox 1226 is provided at a rearward end of the engine 1210, with the high pressure compressor 1229, low pressure turbine 1243, high pressure turbine 1231, combustor 1230 and low pressure compressor 1228 being provided in sequence extending forwardly. However, the core air A is directed through the low pressure compressor 1228, intercooler 1257, high pressure compressor 1229, combustor 1230, high pressure turbine 1231 low pressure turbine 1243 and recuperator 1248 in flow series.

The high pressure compressor 1229, low pressure turbine 1243 and gearbox 1226 are interconnected by a low pressure fan drive shaft 1227. The gearbox drives the output shafts 1225a, 1225b. A high pressure shaft 1277 interconnects the low pressure compressor 1228 and high pressure turbine 1231. Again, in this embodiment, the shafts 1227, 1277 are not concentric, and so the shaft arrangement is simplified, and the engine can have a narrower diameter, which decreases core nacelle drag. Referring again to FIG. 24, the engine core 1276 is mounted to a lower surface of a wing (not shown) by a pylon 1260, and each fan 1213a, 1213b is mounted to the core engine 1276.

FIG. 27 illustrates a twelfth gas turbine engine 1310. The engine 1310 comprises first and second fans (only one of which, 1313a, is shown in FIG. 27 for clarity) of similar construction to the fans 113a, 113b of the engine 110. Each fan is similarly driven by respective output shafts 1325a, 1325b which are in turn driven by a gearbox 1326, which is in turn driven by an input shaft in the form of a fan drive turbine shaft 1327. Again, the fans 1313 are located at a rearward end of the engine 1310, downstream of the gearbox 1326.

The fan drive turbine shaft 1327 is driven by a core engine 1375. Engine 1310 comprises a core engine 1375 having first and second core modules 1390, 1391. The first core module 1390 comprises a first compressor in the form of a low pressure compressor 1328 and a first turbine in the form of a high pressure turbine 1331 interconnected by a first shaft in the form of a high pressure shaft 1377. The core 1375 further comprises a second core module 1391 comprising a second compressor in the form of a high pressure compressor 1343 and a fan drive turbine 1329 interconnected by a second shaft in the form of a low pressure shaft 1327. The first and second modules 1390, 1391 are separated in an axial direction X. In this embodiment, each component of the first module 1390 is provided forwardly of each component of the second module 1391. Again, though the shafts 1327, 1377 rotate about a common engine axis, the shafts do not overlap in an axial direction.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, the fans could comprise fixed pitch blades. In such a case, a cold flow thrust reverse mechanism may be provided. Where the fans are powered by electrical motors, the fans could be located remotely from the engine core. For example, the engine core could be located in the tail, with the fans located on the wings.

The first and second shafts need not be co-axial, and could be offset relative to one another.

1. An aircraft gas turbine engine comprising:
first and second non-coaxial propulsors, each propulsor being driven by a common gas turbine engine core comprising a propulsor drive turbine arranged to drive the first and second propulsors via a propulsor drive coupling;
wherein the core comprises a first core module comprising a first compressor and a first turbine interconnected by a first shaft, and a second core module comprising a second compressor and the propulsor drive turbine interconnected by a second shaft, the first and second core modules being axially spaced.

2. A gas turbine engine according to claim 1, wherein the core comprises a compressor provided axially rearwardly of the propulsor drive turbine.

3. A gas turbine engine according to claim 1, wherein each propulsor comprises a ducted fan or an un-ducted propeller.

4. A gas turbine engine according to claim 1, wherein the propulsor drive coupling is arranged such that the propulsor drive turbine rotates at a higher rotational speed than the propulsor in use.

5. A gas turbine engine according to claim 4, wherein the propulsor drive coupling comprises a reduction gearbox comprising a common input shaft coupled to the propulsor drive turbine, and first and second output shafts coupled to the first and second propulsors respectively.

6. A gas turbine engine according to claim 4, wherein the propulsor drive coupling comprises a propulsor drive turbine driven electrical generator and first and second electrical motors coupled to respective propulsors, the generator being electrically coupled to the first and second motors.

7. A gas turbine engine according to claim 5, wherein the gearbox comprises a differential drive.

8. A gas turbine engine according to claim 1, wherein the propulsors comprise variable pitch rotor blades.

9. A gas turbine engine according to claim 1, wherein the engine core comprises a core inlet configured to receive free stream air from between the first and second fans.

10. A gas turbine engine according to claim 1, wherein the engine core comprises a low pressure compressor coupled to the fan drive turbine by a low pressure shaft, and a high pressure turbine coupled to a high pressure compressor by a higher pressure shaft.

11. A gas turbine engine according to claim 10, wherein the high pressure compressor comprises one or more axial compressor stages upstream in core flow of one or more centrifugal compressor stages.

12. A gas turbine engine according to claim 10, wherein the low pressure compressor is provided axially forwardly of the low pressure turbine, and may be provided axially forwardly of the gearbox.

13. A gas turbine engine according to claim 1, wherein the engine comprises a core inlet configured to ingest fan air.

14. A gas turbine engine according to claim 1, wherein the engine comprises a low pressure compressor and a high pressure compressor and an intercooler arrangement configured to cool compressed air from an outlet of the low pressure compressor upstream in core air flow of an inlet of the high pressure compressor.

15. A gas turbine engine according to claim 14, wherein the intercooler arrangement comprises a compressed air duct extending between the low pressure compressor outlet and the high pressure compressor inlet, and a cooling air duct configured to exchange heat between cooling air within the cooling duct and compressor air within the compressed air duct, the cooling air duct comprising a flow modulation valve configured to modulate air mass flow through the cooling air duct.

16. A gas turbine engine according to claim 1, wherein the gas turbine engine comprises a recuperator arrangement configured to exchange heat between air exhausted from the fan drive turbine and air exiting the compressor prior to entering a combustor.

17. An aircraft comprising a gas turbine engine in accordance with claim 1.

18. An aircraft according to claim 17, wherein the first and second fans of the gas turbine engine may be located underneath a wing of the aircraft.

19. An aircraft according to claim 17, wherein the core inlet is provided within the aircraft wing.

20. An aircraft according to claim 17, wherein the core inlet is configured to ingest air adjacent a trailing edge of the wing, adjacent an upper wing surface.
